(19) United States
(12) Patent Application Publication
(10) Pub. No.: US 2006/0185776 A1
(43) Pub. Date: Aug. 24, 2006

(54) Pneumatic tire tread

(76) Inventor: Kun Lu, Guangzhou (CN)

Correspondence Address: GREENBERG TRAURIG LLP, 2450 COLORADO AVENUE, SUITE 400E, SANTA MONICA, CA, 90404, US

(21) Appl. No.: 11/345,083

(22) Filed: Jan. 31, 2006

Related U.S. Application Data
(60) Provisional application No. 60/656,255, filed on Feb. 24, 2005.

(51) Int. Cl. B60C 11/13

(52) U.S. Cl. 152/209.28; 152/209.22

(57) ABSTRACT

A pneumatic tire comprising a plurality of wishbone shaped patterns, each comprising a first substantially inclined circumferential groove and a second substantially inclined circumferential groove; and a plurality of curved, substantially lateral grooves, wherein each first substantially inclined circumferential groove and each second substantially inclined circumferential groove is intersected by at least one substantially lateral groove, and each of the inclined circumferential and lateral grooves is perpendicular with the turning axis of the tire.

### CROSS REFERENCE TO RELATED APPLICATIONS

This application claims the benefit of Provisional U.S. Patent Application Ser. No. 60/656,255, filed on Feb. 24, 2005, entitled PNEUMATIC TIRE, the disclosure of which is hereby incorporated by reference in its entirety.

### FIELD OF THE DISCLOSURE

This disclosure relates to pneumatic tires and more specifically to the tread pattern of a pneumatic tire.

### DESCRIPTION OF RELATED ART

The performance of a pneumatic is greatly affected by the way blocks and grooves, which compose the tire tread pattern, interact with the road surface. Performance factors may include road grip, response too steering, general maneuvering stability and noise emission. The shape, location and sequence of impact upon the road, of blocks and grooves in a tire impact those factors.

Tires should grip the road well both under dry and wet conditions, and be responsive to steering commands under both conditions. Also at high and low speed, the tires should provide good straight line movement for the vehicle.

However, varying road and driving conditions may call for competing tread solutions. For example, a tire's wet road grip depends to a great extent on the size and configuration of the grooves and it is generally improved by tread designs having a larger groove area. On the other hand, to improve a tire's dry road grip, it is helpful to increase the tire's contact area with the road to get a better traction, which is achieved by tread designs having an increased the block dimension and reduced groove area.

Lowering the noise emission generated upon contact of the tire tread surface with the ground generally requires a careful calculation of size shape and configuration of grooves and blocks in the tread design of a tire. This in view of different kind of noise emissions which requires different design solutions. For example, the noise generated by vibration of the blocks and by compression and release of the air in the grooves upon contact of the tire surface with the ground, is lowered in designs having a reduced groove area and enlarged block dimensions. On the other hand, the noise generated by the contact of the tire tread surface area with the ground, is lowered in designs having a reduced tread surface area and an enlarged groove area.

The tire's grip under different driving and road conditions, driving comfort and maneuvering stability are also affected by location and configuration of grooves and blocks on the different portions of the tire surface. For example, presence, number and shape of lateral grooves on the shoulder of the tires, affect water drainage. Also number dimensions and rigidity of the blocks on the shoulder portions of the tire affect the tire's maneuvering stability during turns, wear and tear of the tire.

As a consequence, a tire tread pattern configuration optimized to achieve a high performance, wherein traction, stability and noise emission are optimized, is a desideratum.

### SUMMARY OF THE DISCLOSURE

A pneumatic tire is disclosed with a tread pattern to achieve a high performance. The pneumatic tire comprises: a plurality of wishbone shaped patterns, each pattern comprising a first substantially inclined circumferential groove and a second substantially inclined circumferential groove; and a plurality of curved, substantially lateral grooves, wherein each first substantially inclined circumferential groove and each second substantially inclined circumferential groove is intersected by at least one substantially lateral groove. Each of the inclined circumferential and lateral grooves perpendicular with the turning axis of the tire.

The first substantially inclined circumferential groove has a first end and a second end, wherein the first end is closed end and the second end is connected with a different wishbone shaped pattern.

The second substantially inclined circumferential groove has a first closed end and a second end connected with the first substantially inclined circumferential groove.

The first substantially inclined circumferential groove comprises a substantially linear portion forming a first angle with a centerline of the pneumatic tire and the second substantially inclined circumferential groove comprises a substantially linear portion forming a second angle with the tire centerline, which is substantially perpendicular to the turning axis of the tire. The first angle is preferably a mirror image of the second angle with respect of the tire circumferential centerline. Each of the first angle and second angle can be in a range from about 23° to about 38°. Preferably, the first angle is 30° and the second angle is 30°.

Each first substantially inclined circumferential groove and each second substantially inclined circumferential groove is intersected by three substantially lateral grooves.

A first and third groove of the three substantially lateral grooves are longer than a second groove of the three substantially lateral grooves. The first and third grooves are substantially of a same length. Preferably, the lateral grooves have mirror image symmetry with respect to the tire circumferential center line.

The substantially lateral grooves comprise an external portion and an internal portion, wherein the external portion of is provided with an open end. The open-end can have a width in a range from about 5 to about 8 mm.

In some exemplary implementations the pneumatic tire has reinforcement bars provided adjacent an intersection between substantially inclined circumferential grooves of a same wishbone shaped pattern or between substantially inclined circumferential grooves of neighboring wishbone shaped patterns. The reinforcement bars can be provided in a range from about 0 to about 10 mm area adjacent the intersection. Intersections between the substantially inclined circumferential grooves and the substantially lateral grooves form contact areas.

The pneumatic tire can be used as a passenger-car air-inflated meridian tire, such as such as ultra high performance, sport performance and luxury, in particular for passenger cars such as SUV/MPV/RV e.g. pickups and light trucks.

In some exemplary implementations the pneumatic tire's grip under both dry and wet road conditions, as well as the tire's high speed performance, steering stability and riding comfort.

Other features and advantages of the present invention will be set forth in the following description and accompanying drawings, where the preferred embodiments of the present invention are described and shown. Additional details will become apparent to those skilled in the art upon examination of the detailed description taken in conjunction with the accompanying drawings or may be learned by practicing the present invention. The advantages of the present invention may be realized and attained by means of the instrumentalities and combinations particularly pointed out in the appendent claims.

### BRIEF DESCRIPTION OF THE DRAWINGS

FIG. 1 is a schematic representation of a wishbone shaped pattern of the present disclosure.

FIG. 2 illustrates a landscape view of the tire tread design of the present disclosure.

FIG. 3 illustrates a landscape view of the tire tread design of the present disclosure showing where section views were taken for FIGS. 4 to 8.

FIG. 4 illustrates a section view of the tread design of the present disclosure taken along the lines 4-4 of FIG. 2.

FIG. 5 illustrates a section view of the tread design of the present disclosure taken along the lines 5-5 of FIG. 2.

FIG. 6 illustrates a section view of the tread design of the present disclosure taken along the lines 6-6 of FIG. 2.

FIG. 7 illustrates a section view of the tread design of the present disclosure taken along the lines 7-7 of FIG. 2.

FIG. 8 illustrates a section view of the tread design of the present disclosure taken along the lines 8-8 of FIG. 2.

FIG. 9 illustrates a section view of the tread design of the present disclosure taken along the lines 9-9 of FIG. 2.

### DETAILED DESCRIPTION

The tread design of the pneumatic tire discussed herein includes a number of repeating and overlapping wishbone shaped patterns.

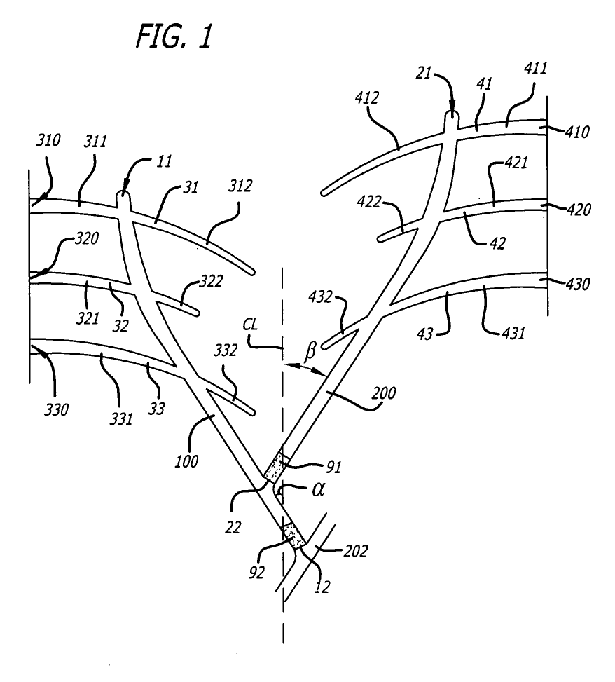

FIG. 1 shows one of the repeating wishbone shaped patterns. The pattern comprises two intersecting, inclined circumferential grooves denominated as first inclined circumferential grove 100 and second inclined circumferential groove 200. First inclined circumferential groove 100 has ends denominated as first end 11 and second end 12. Second inclined circumferential groove 200 has ends denominated as third end 21 and fourth end 22.

Second end 12 of first inclined circumferential groove 100 is connected with and intersects third inclined circumferential groove 202 of another repeating wishbone shaped pattern of the tire tread design. Fourth end 22 of second inclined circumferential groove 200 is connected with and intersects first inclined circumferential groove 100.

The first end 11 and third end 21, and similar respective terminal ends in the repeating structures, are not extended further to the next intersection of the respective lateral grooves in order to avoid carving up the surface of the tire into too many blocks. The rigidity of the blocks, especially at the shoulders of the tire, correlates to road grip and turning smoothness. Therefore, the size and number of blocks is controlled to achieve the desired tire characteristics.

Located in proximity of the second end 12 and fourth end 22 are reinforcement bars 91 and 92. Reinforcement bar 91 is located along inclined circumferential groove 100. Reinforcement bar 92 is located along inclined circumferential groove 200. Reinforcement bars 91, 92 extend along a fraction of inclined circumferential grooves 100, 200, respectively. Each reinforcement bar can be, for example, 10 mm long. Reinforcement bars 91 and 92 are raised with respect to the surface of the tire, as later shown in FIG. 6 in more detail.

Turning to FIG. 1, reinforcement bar 91 is located adjacent an intersection between inclined circumferential groove 100 and inclined circumferential groove 200 of a same wishbone shaped pattern. Reinforcement bar 92 is located adjacent an intersection between inclined circumferential groove 100 of a first wishbone shaped pattern and inclined circumferential groove 202 of a second, adjacent wishbone shaped pattern.

The reinforcement bars 9 reduce curling of the edges of the grooves near the intersections, thereby reducing wear and enhancing the road grip and response of the tire, especially during cornering, when the tire experiences increased lateral forces.

A centerline CL corresponding to the centerline of the tire is identified in FIG. 1. The first and second inclined circumferential grooves 100, 200 form angles α, β, respectively, with the centerline CL. In one embodiment of the invention, angles α and β can assume any values included in a range from about 23° to about 38°. For example, α can be equal to β and can be 30°.

The repeating wishbone shaped pattern also comprises a plurality of lateral grooves and disposed near the tire shoulders. Each inclined circumferential groove is intersected by at least one lateral groove. In the embodiment shown in FIG. 1, each inclined circumferential groove intersects three lateral grooves. In FIG. 1, each of depicted lateral grooves 31-33 and 41-43 has a curved shape. Lateral grooves 31-33 intersect inclined circumferential groove 100 and lateral grooves 41-43 intersect inclined circumferential groove 200.

Although six lateral grooves are shown in FIG. 1, the number of lateral grooves per pattern may be lower or higher, so long as such number is balanced with the noise produced by the tread pattern. The number and shapes of the inclined circumferential grooves and lateral grooves in the disclosed embodiment were chosen to provide effective road grip, sufficient water drainage and reduced noise production.

Turning to FIG. 1, lateral grooves 31, 32 and 33 include outer (toward the tire shoulder) portions 311, 321 and 331 and inner (toward the centerline CL) portions 312, 322 and 332. Lateral grooves 41, 42 and 43 include outer portions 411, 421 and 431, and inner portions 412, 422 and 432.

The lateral grooves shown in FIG. 1 continue along the shoulders of the tire. Thus, the grooves 31-33 are open-ended at their ends 310-330, respectively. Similarly, the grooves 41-43 are open-ended at their ends 410-430.

Each end 310-330 or 410-430 can be between approximately 5 mm to approximately 8 mm wide. In other embodiments, the acceptable widths of 310 and 330 can be from about 7 mm to about 9 mm, the width of 320 can be from about 5 mm to about 7 mm. Therefore, embodiments are present where the width of end 320 or 420 is less than the width of ends 310, 330 or ends 410, 430. In particular, the ratio between width 320 and width 310 or between width 320 and width 330 (and, similarly, between width 420 and width 410 or between width 420 and width 430) is in the range of about 1.2 and about 1.4.

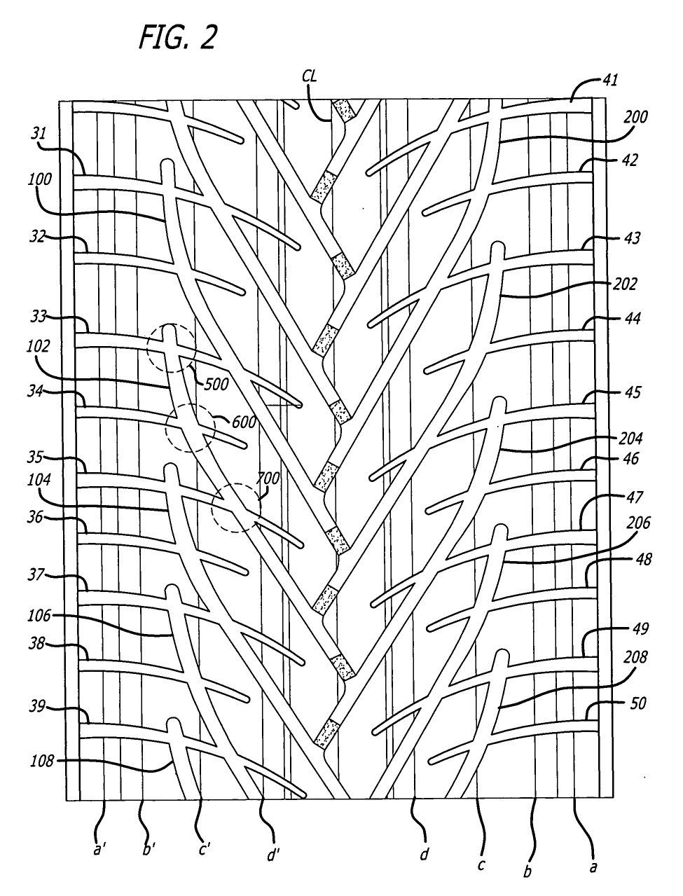

FIG. 2 shows a tire tread design including a plurality of repeating and overlapping wishbone shaped patterns, forming an overall tire tread design.

Several inclined circumferential grooves are shown, for example at numerals 100, 102, 104, 106, 108, 200, 202, 204, 206 and 208, and several lateral grooves are depicted, for example at numerals 31-39 and 41-50. The patterns are repeating.

The tire tread design comprises shoulder areas, a tire tread center portion located between the shoulders and a main ground-contacting portion. The shoulder areas are generally between lines a-c and a′-c′ of FIG. 2. The tire tread center portion is generally identified in FIG. 2 as the area between lines c-c′. The main ground contacting portion is generally the area between lines b-b′.

FIG. 2 shows how the inclined circumferential grooves are connected in a staggered manner. In particular, inclined circumferential groove 100 of a first wishbone shaped pattern is not only connected with inclined circumferential groove 200 of the first wishbone shaped pattern, but also with inclined circumferential groove 202 of a second wishbone shaped pattern. Similarly, inclined circumferential groove 202 of the second wishbone shaped pattern is connected with not only with inclined circumferential groove 102 of the second wishbone shaped pattern, but also with inclined circumferential groove 100 of the first wishbone shaped pattern.

Staggering of the various grooves as shown above allows the noise amplifying effect of the various patterns to be reduced.

Intersections between inclined circumferential grooves and lateral grooves form intersection areas. As depicted in FIG. 2, the intersections between the inclined circumferential groove 102 and the lateral grooves 33, 34 and 35, for example, form intersection areas 500, 600 and 700. In some embodiments, the width of the intersection areas 500, 600 and 700 can be about 1.0 to 1.3 times the distance between two neighboring inclined circumferential grooves.

Preferably, the total area of the pattern blocks is 60-70% of the area of the ground-contacting portion (the area ratio). The area ratio of the embodiment shown in FIG. 2 is 64%.

The blocks and the grooves, with reference to the inclined circumferential revolving axle of the tire (RA), are asymmetrical on either side of the axle (RA).

Noise waves of tread designs having pitches of equal values have frequency components at a frequency which is an even-number multiple of the basic frequency of the tire. This results in an increase of the noise level of the tire.

According to an embodiment of the present disclosure, the noise level of the tire is reduced by providing sections of five different pitches, identified herein as sections I-V and by alternating those sections.

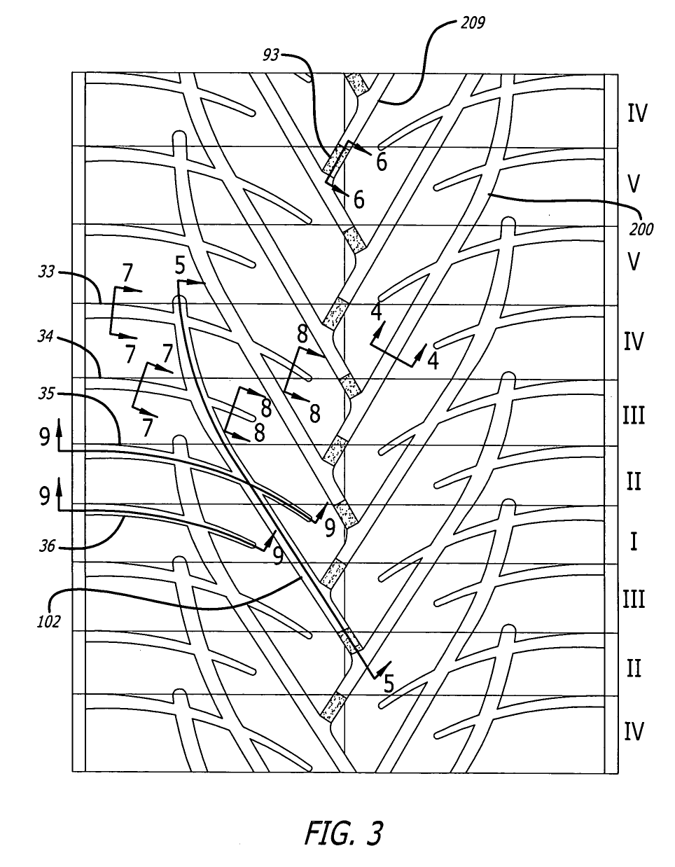

FIG. 3 shows a tread pattern where sections I-V are identified. The length (pitch) of each section is different, with section I being the section having the shortest pitch and section V being the section having the longest pitch. For example, section I has a length of 33 mm, section II has a length of 37 mm, section III has a length of 41 mm, section IV has a length of 45 mm, and section V has a length of 47 mm.

The relative length of the various sections can also be expressed as a length ratio between each section II-V and section I. According to a preferred embodiment, the ratio between section II and section I is in a range between 1.07 and 1.14, the ratio between section III and section I is in a range between 1.20 and 1.29, the ratio between section IV and section I is in a range between 1.33 and 1.38, and the ratio between section V and section I is in a range between 1.49 and 1.56.

In the preferred embodiment, each tire is provided with 62 sections: 13 sections I, 13 sections II, 14 sections III, 12 sections IV, and 10 sections V. In a further embodiment, the number of sections can vary between 50 and 70 sections. Further, in the preferred embodiment, the ratio between the length of each of Sections I-V and the total circumferential length of the tire is 17%, 19%, 23%, 21% and 20%, respectively. Therefore, a pitch sequence respecting the above parameters allows noise to be reduced.

FIG. 3 also shows sectional lines 4-4, 5-5, 6-6, 7-7, 8-8 and 9-9.

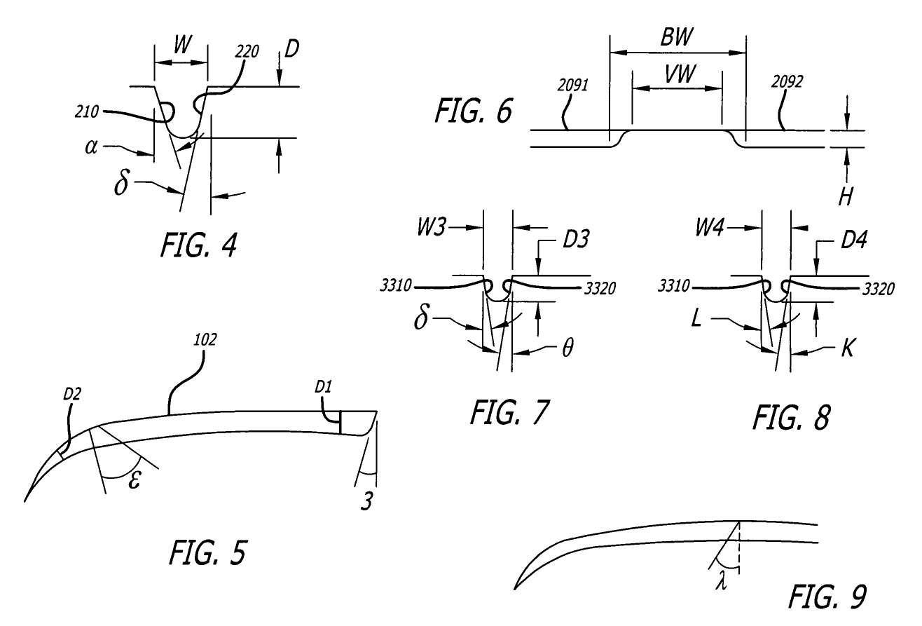

FIG. 4 shows a sectional view taken along line 4-4 of FIG. 3. In particular, a sectional view of an inclined circumferential groove 200 is shown. Groove 200 has a width W and a depth D. The side walls 210, 220 of inclined circumferential groove 200 are inclined with respect to a vertical direction of FIG. 4. In particular, side wall 210 has an inclination γ and side wall 220 has an inclination δ. Similar considerations apply to the cross section of inclined circumferential groove 100.

Choice of the values for the width D and the depth D affects the performance of the tire. A small volume D×W of the inclined circumferential grooves 100, 200 reduces the noise produced by the tire, but it also reduces the tire's traction and wearability. Therefore, a desired balance has to be obtained between the desired effects.

Further, it should be noted that the width W of each inclined circumferential groove 100, 200 is not necessarily the same along the groove, and can vary in a continuous manner. For example, the width W can have a first value along a first portion of the groove and a second value along a second portion of the groove. FIG. 2 shows an example of an inclined circumferential groove 102 having a varying width W.

According to a preferred embodiment, inclined circumferential groove 102 has a width from about 7 mm to about 10 mm. In particular, the width W of inclined circumferential groove 102 has a first value between the intersection of inclined circumferential groove 102 with inclined circumferential groove 204 and intersection area 700, and then varies continuously between intersection area 700 and intersection area 500. For example, in the embodiment shown in FIG. 2 the width of circumferential groove 204 increases from intersection area 700 to intersection area 600, and then decreases from intersection area 600 to intersection area 500. In particular, in a preferred embodiment, the width W1 (not shown) at intersection area 600 is 1.2 to 1.4 times the width W2 (not shown) at intersection area 700.

Turning to FIG. 4, the depth D of an inclined circumferential groove can range from about 8.0 to about 10.0 mm and is preferably constant along the groove.

The side walls 210, 220 of the inclined circumferential groove shown in FIG. 4 are inclined at angles γ and δ. The engineering of angles γ, δ influences the rigidity of the pattern blocks, thereby impacting on the tire's maneuverability, wear and tear, noise level and water drainage ability. In the absence of pressure, the tire tread surface assumes an arc shape especially along the portion including the inclined circumferential grooves 100 and 200. Upon contact of the tire with the ground, the blocks and grooves change shape under the weight and driving force of the car. Under pressure, the angles of the grooves 100 and 200 change, so do the groove walls 210 and 220, with the side 220 (closer to δ) subject to a smaller change, and the side 210 (closer to γ) subjected to a higher change. In order to take this difference of behavior of sides 210 and 220, there is a difference in the values of γ and δ, with γ higher than δ. According to a preferred embodiment, γ−δ=5°, with δ>10°. In the example shown in FIG. 4, the value of angle γ is about 17°, and the value of angle δ is about 12°.

FIG. 5 shows a sectional view taken along line 5-5 of FIG. 3. In other words, FIG. 5 shows a cross-sectional view of the inclined circumferential groove 102 of FIG. 3 taken along line 5-5 of FIG. 3. As shown in FIG. 5, the depth D of inclined circumferential groove 102 is variable. For example, depth D1 at the right side of FIG. 5 is higher than depth D2 at the left side of FIG. 5. It should also be noted that, in accordance with the embodiment shown in FIG. 5, the depth of the inclined circumferential groove 102 is substantially constant along a substantially central portion of the inclined circumferential groove 102. In accordance with a first embodiment, the depth of inclined circumferential groove 102 varies between about 8 and about 9 mm, with the depth of the substantially central portion being of about 9 mm.

FIG. 5 also shows angles ε and ζ. Angle ζ corresponds to the wall angle γ shown in FIG. 4, in the sense that angles ζ and γ are two-dimensional projections of a single three-dimensional angle. An abrupt decrease in depth of the inclined circumferential groove 102 can be controlled by controlling the angle ε. Preferably, ε varies between about 30° and about 60°. Most preferably, ε has a value of about 45°.

FIG. 6 shows a sectional view taken along line 6-6 of FIG. 3, i.e. along one of the reinforcement bars described above with reference to FIG. 1. Reinforcement bar 93 of FIG. 6 is raised with respect to the bed of the channel 2091, 2092 of the inclined circumferential groove 209. FIG. 6 also shows a base width BW, an upper width UW and a height H of the reinforcement bar 93. Preferably, BW is from about 15 to about 18 mm and H is from about 1.6 to about 1.8 mm.

The teachings described with reference to FIGS. 4-6 apply to inclined circumferential grooves 100-108 and 200-209.

FIGS. 7-9 make reference to the lateral grooves 31-39 and 41-50 (see FIG. 2). FIGS. 7 and 8 are the lateral groove equivalent of FIG. 4. FIG. 9 is the lateral groove equivalent of FIG. 5.

FIG. 7 shows a sectional view taken along line 7-7 of FIG. 3. In particular, a sectional view of lateral groove 33 or 34 is shown in a portion of the lateral groove which is nearer the side of the tire, for example lateral groove 33. Groove 33 has a width W3 and a depth D3 along section 7-7. The side walls 3310, 3320 of lateral groove 33 are inclined with respect to a vertical direction of FIG. 7. In particular, side wall 3310 has an inclination η along section 7-7 and side wall 3320 has an inclination θ along section 7-7. Similar considerations apply to the cross section of other lateral grooves. Similarly to what described with respect to the inclined circumferential grooves, width W3 and depth D3 are not necessarily constant and can vary along the lateral groove. For example, depth D3 can vary between about 8 mm and about 9 mm. Usually, depth D3 is 8 mm when depth D of the inclined circumferential grooves is 10 mm. Further, with reference to the inclination angles η and θ, the applicants have found that preferred values are between about 7° and about 10°. The value of η and θ in the embodiment shown in FIG. 7 is 8°.

The variation of width and depth along the lateral grooves can be better understood with reference to FIG. 8. FIG. 8 shows a sectional view taken along line 8-8 of FIG. 3. In particular, a sectional view of lateral groove 33 or 34 is shown in a portion of the lateral groove which is nearer the centerline CL, for example lateral groove 33. Groove 33 has a width W4 and a depth D4 along section 8-8. Also in this case, the side walls 3310, 3320 of lateral groove 33 are inclined with respect to a vertical direction of FIG. 8. In particular, side wall 3310 has an inclination τ along section 8-8 and side wall 3320 has an inclination κ along section 8-8. Similarly to what described with reference to FIG. 7, the preferred values for the angles τ and κ are between about 7° and about 10°, and the value shown in the Figure is 8°.

FIG. 9 shows a sectional view taken along line 9-9 of FIG. 3. In other words, FIG. 9 shows a cross-sectional view of lateral grooves 35, 36, for example groove 35, of FIG. 3 taken along lines 9-9 of FIG. 3. As shown in FIG. 9 and similarly to what shown in FIG. 5, the depth of groove 35 is variable. However, the pattern of variability of the depth of the lateral grooves can be different from the pattern of variability of the depth of the circumferential grooves. FIG. 9 also shows angle λ. Similarly to angle ε of FIG. 5, angle λ can have values between about 30° and about 60°. In the embodiment depicted in FIG. 9, λ is 45°.

Since certain changes may be made in the above apparatus and methods without departing from the scope of the invention herein involved, it is intended that all matter contained in the above description, as shown in the accompanying drawing, shall be interpreted in an illustrative and not limiting sense. It is not intended that the invention be limited to the illustrative embodiments.

It should also be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

1. A pneumatic tire comprising:
a plurality of wishbone shaped patterns, each pattern comprising a first substantially inclined circumferential groove and a second substantially inclined circumferential groove; and
a plurality of curved, substantially lateral grooves, wherein each first substantially inclined circumferential groove and each second substantially inclined circumferential groove is intersected by at least one substantially lateral groove,
each of the inclined circumferential and lateral grooves perpendicular with the turning axis of the tire.

2. The pneumatic tire of claim 1, wherein the first substantially inclined circumferential groove has a first closed end and a second end connected with a different wishbone shaped pattern.

3. The pneumatic tire of claim 1, wherein the second substantially inclined circumferential groove has a first closed end and a second end connected with the first substantially inclined circumferential groove.

4. The pneumatic tire of claim 1, wherein the first substantially inclined circumferential groove comprises a substantially linear portion forming a first angle with a centerline of the pneumatic tire and the second substantially inclined circumferential groove comprises a substantially linear portion forming a second angle with the centerline.

5. The pneumatic tire of claim 4, wherein the first angle is 30 degrees and the second angle is 30 degrees.

6. The pneumatic tire of claim 1, wherein each first substantially inclined circumferential groove and each second substantially inclined circumferential groove is intersected by three substantially lateral grooves.

7. The pneumatic tire of claim 6, wherein a first and third groove of the three substantially lateral grooves are longer than a second groove of the three substantially lateral grooves.

8. The pneumatic tire of claim 7, wherein the first and third groove are substantially of a same length.

9. The pneumatic tire of claim 1, wherein the substantially lateral grooves comprise an external portion and an internal portion, the external portion of the substantially lateral grooves being open-ended.

10. The pneumatic tire of claim 9, wherein the external portion ends have a width in a 5-8 mm range.

11. The pneumatic tire of claim 1, further comprising reinforcement bars provided adjacent an intersection between substantially inclined circumferential grooves of a same wishbone shaped pattern or between substantially inclined circumferential grooves of neighboring wishbone shaped patterns.

12. The pneumatic tire of claim 10, wherein the reinforcement bars are provided in a 0-10 mm area adjacent the intersection.

13. The pneumatic tire of claim 1, wherein intersections between the substantially inclined circumferential grooves and the substantially lateral grooves form intersection areas.
